(19) United States
(12) Patent Application Publication
(10) Pub. No.: US 2014/0257932 A1
(43) Pub. Date: Sep. 11, 2014

(54) SEGMENT ASSIGNMENT OPTIMIZATION ENGINE

(71) Applicant: BANK OF AMERICA CORPORATION, Charlotte, NC (US)

(72) Inventors: David Joa, Irvine, CA (US); Timothy J. Bendel, Charlotte, NC (US)

(73) Assignee: Bank of America Corporation, Charlotte, NC (US)

(21) Appl. No.: 13/785,689

(22) Filed: Mar. 5, 2013

(51) Int. Cl. G06Q 30/02

(52) U.S. Cl. CPC G06Q 30/0204
USPC 705/7.34; 705/7.33

(57) ABSTRACT

Embodiments of the invention are directed to systems, methods, and computer program products for assigning a user to a user segment. In some embodiments, a system is configured to: receive transaction data associated with a user; analyze the transaction data; identify a user segment based on the analysis of the transaction data; and assign a user to the user segment.

### BACKGROUND

When an entity (e.g. a financial institution) has a large user base, there is a need to group users into segments as efficiently as possible.

### BRIEF SUMMARY

Embodiments of the invention are directed to systems, methods, and computer program products for assigning a user to a user segment. In some embodiments, an apparatus is provided for assigning a user to a user segment. The apparatus comprises: a memory, a processor, and a module stored in the memory, executable by the processor, and configured to: receive transaction data associated with a user; analyze the transaction data; identify a user segment based on the analysis of the transaction data; and assign a user to the user segment.

In some embodiments, receiving transaction data further comprises searching a datastore of stored transaction data.

In some embodiments, the transaction data comprises an image, text, data, or metadata.

In some embodiments, the transaction data comprises information from a deposit, a check, a receipt, a withdrawal, a funds transfer, or a bill pay.

In some embodiments, at least one of the first information or the second information comprises information associated with a purchase transaction, wherein the information comprises at least one of location information, a transaction type, a transaction date, a type of payment, a payment amount, a tip, a tax, or a discount associated with the transaction.

In some embodiments, location information comprises geo-location information, a longitude and latitude, global positioning system (GPS) coordinates, a physical address, or a network address.

In some embodiments, analyzing the transaction data further comprises developing a map of logic statements.

In some embodiments, the map of logic statements determines the user segment for the user.

In some embodiments, analyzing the transaction data further comprises associating a probability of relevance to at least one user segment applicable to the user.

In some embodiments, analyzing the transaction data further comprises ranking the at least one user segment based on the probability of relevance of each user segment in order to determine the user segment for the user.

In some embodiments, analyzing the transaction data further comprises creating a record of the user's transaction data.

In some embodiments, identifying the user segment further comprises matching the user with the user segment based on a probability of relevance of the user segment.

In some embodiments, wherein assigning the user to the user segment further comprises associating the user and the transaction data with the user segment.

In some embodiments, the user is assigned to at least one user segment.

In some embodiments, the user segment is divided into at least one micro segment.

In some embodiments, an agent associated with the apparatus targets and transmits to the user segment offers, products, services, marketing materials, or information.

In some embodiments, the apparatus automatically transmits offers, marketing materials, products, services, or information to the user segment based on a probability of relevance associated with the user segment.

In some embodiments, an agent associated with the apparatus determines a criterion and a name for the user segment.

In some embodiments, a method is provided for assigning a user to a user segment. The method comprises: receiving transaction data associated with a user; analyzing the transaction data; identifying a user segment based on the analysis of the transaction data; assigning a user to the user segment.

In some embodiments, a computer program product is provided for assigning a user to a user segment. The computer program comprises a non-transitory computer-readable medium comprising a set of codes for causing a computer to: receive transaction data associated with a user; analyze the transaction data; identify a user segment based on the analysis of the transaction data; assign a user to the user segment.

### BRIEF DESCRIPTION OF THE DRAWINGS

Having thus described embodiments of the invention in general terms, reference will now be made to the accompanying drawings, where:

FIG. 1 is a general process flow for assigning a user to a user segment, in accordance with embodiments of the present invention;

FIG. 2 is a general process flow for defining a user segment, in accordance with embodiments of the present invention;

FIG. 3 is an exemplary user interface for viewing and interacting with a data crumb, as well as defining a user segment, in accordance with some embodiments of the present invention;

FIG. 4 is an exemplary user interface for selecting the user segments for the user based on the associated probability scores, in accordance with embodiments of the present invention;

FIG. 5 is a block diagram illustrating technical components of a system, in accordance with embodiments of the present invention;

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for identifying a user segment and assigning a user to the user segment, in accordance with embodiments of the present invention.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g. a banking account), a savings account, an investment account, a money market account, a time deposit, a demand deposit, a pre-paid account, a credit account, a non-monetary user profile that includes only personal information associated with the user, or the like. The account is associated with and/or maintained by an entity. In other embodiments, an “entity” may not be a financial institution.

In some embodiments, the “user” may be a customer (e.g. an account holder or a person who has an account (e.g. banking account, credit account, or the like) at the entity). The user may also be an agent (customer service representative, internal operations specialist, bank teller, account manager, or the like) associated with the entity. The user may also refer to the customer, and vice versa.

In some embodiments, “transaction data” may refer to information associated with a wide range of financial transactions, including but not limited to fund transfers, fund deposits, fund withdrawals, bill pays, or the like. In some embodiments, transaction data may be collected from a financial document or an image of a financial document, wherein the financial document comprises a check, a lease document, a mortgage document, a deposit slip, a payment coupon, a receipt, or the like. For example, transaction data may comprise an account number, a check number, an amount, a payee, a memo description, a transaction date, or the like. In some embodiments, the financial document may exist as a physical item printed on paper or other medium. In some embodiments, the financial document may exist electronically. In some embodiments, transaction data may be proprietary to the entity. In some embodiments, transaction data may be public information. In other embodiments, transaction data may be associated with the user, the user's customer account, or the like. Examples of transaction data associated with the user may be contact information, account information, or the like.

When an entity has a large user base, there is a need to organize the user base as efficiently as possible. Dividing the large user base into smaller groups (user segments) may enable the entity to more precisely understand specific profiles of its user base. From this understanding, the entity may target and tailor its advertisements, marketing materials, offers, product information, services, or the like to selective user groups of the large user base. The entity may better know the type of user that the entity attracts and services. Ultimately, the utilization of user segments may increase efficiency in the intelligence of the entity's data collection and digital distribution systems.

The present invention may enable an apparatus (e.g. a computer system) associated with the entity to amass a database of data crumbs (pieces of information deemed by the entity or apparatus to be critical in identifying user profiles or user segments) through an automated process. In some embodiments, data crumbs may be text. In some embodiments, data crumbs may be an image. In some embodiments, data crumbs may be data or metadata. In some embodiments, data crumbs may be information associated with a location. In some embodiments, data crumbs may be proprietary transaction data. For example, the data crumbs may contain information in regards to a recent transaction and include information pertaining to a transaction type, a transaction date, a payment type, a payment amount, a tip, a tax, a discount associated with the transaction, location information (longitude and latitude coordinates, global positioning system (GPS) coordinates, or the like. In other embodiments, data crumbs may be information associated with an account and may comprise an account number, a card number, contact information, a history of transactions, or the like.

The purpose of the data crumbs may be to identify the relationships between the user and the types of businesses with which he interacts. An analysis of the relationship between the user and the types of businesses with which he interacts may be used to define user segments. Furthermore, understanding the relationship between the user and the types of businesses with which he interacts may be used to better determine the user segment to which the user is to be assigned. Additionally, the entity may better allocate its resources to process and store large amounts of user information, transaction data, or the like associated with its user base.

The apparatus may retrieve data crumbs by autonomously searching and/or crawling through a website, a text publication, a datastore or database of proprietary transaction data, a social media post, traditional media (news, radio, outdoor ads, or the like) or the like for information associated with said businesses. In some embodiments, the web crawler may comprise a script. In some embodiments, the web crawler or script may verify the validity of the business by cross-referencing the retrieved data crumbs with a variety of factors, including a business website, a target audience, a marketing language, or the like. In some embodiments, the apparatus may comprise computer-readable code or another form of software that executes the retrieval process. In some embodiments, the apparatus may retrieve data crumbs from a source or database internal to the apparatus. In some embodiments, the apparatus may receive data crumbs from a third party web crawler, search engine, public database of user records, or the like. In some embodiments, the data crumbs are transmitted to the apparatus from the user's computing device (mobile device, tablet, laptop, desktop, computer, or the like). In other embodiments, the data crumbs are transmitted to the apparatus from a facility associated with the entity (automatic teller machine (ATM), bank teller station, account manager, internal operations specialist, or the like). Upon receipt of the data crumbs, the apparatus may store the data crumbs in a database associated with and accessible by the apparatus.

After receiving the data crumbs, the apparatus may compare the received data crumbs to other pieces of information (data crumbs, proprietary transaction data, public information on website or in publications, or the like) to verify the validity of the received data crumbs. In some embodiments, the received data crumbs may be compared to proprietary transaction data. The proprietary transaction data may be stored in a datastore or database associated with the entity. In some embodiments, the received data crumbs may be compared to location information. In some embodiments, the received data crumbs may be compared to other data crumbs in the database. Multiple matches of transactions with the same business may enable the apparatus to determine exactly what type or category of industry in which the business operates.

Furthermore, the apparatus may generate and assign a score to the data crumb. The score may measure a consistency in language, tone, diction, dialect, or the like based on a relevance to the user segment. For example, if a financial institution refers to their customers as “clients,” the apparatus may deem retrieved data crumbs that include similar terminology to have a high score. Thus, the generated score may be an effective tool to identify user segments across a wide spectrum of customers. In another example, the generated score may help differentiate between multiple nationalities that use the same language, wherein each nationality has a unique usage of words within the same language. Based on the score, the apparatus may rank or assign a score to the data crumb to identify to which user segment the data crumb is most applicable.

Upon a positive verification of the data crumbs, a positive acknowledgement is generated by the apparatus. The acknowledgement may be transmitted by the apparatus to the user's computing device or to the agent's computing device and may serve as a record of positive verification.

For example, the apparatus may receive from the user a set of data crumbs that indicates a recent transaction. The apparatus may cross-reference the received set of data crumbs with records of previous transactions. If the apparatus discovers that the received set of data crumbs match previous transactions with a certain type of business, say a golf course, then the apparatus may associate the received set of data crumbs with said golf course. This association confirms the identity of the received set of data crumbs with the correct type of business. Moreover, the apparatus may associate the user and the user's information with the golf course. Thus, an ideal user profile may be defined for the type of transactions associated with the received set of data crumbs. The apparatus may search public records or proprietary transaction data for similar users who interact with similar golf courses on a regular basis. Upon finding users with similar profiles, the apparatus may group the users together by certain criteria with some degree of certainty.

The definition of the user segment may be based on a variety of indicators. In some embodiments, the definition of the user segment may be based on an amount of income, either disposable or gross. In the golf example, because golf is often funded with disposable income, the apparatus may define a group of users as users who have a predetermined amount of disposable income to spend on golf. The entity may reserve the right to determine the threshold at which the amount of disposable income is deemed critical in defining the user segment. In some embodiments, the definition of the user segment may be based on user activity, such as spending habits, subscriptions, memberships, or the like. In some embodiments, the user segment may be defined by the amount or type of investments that the user makes. In alternative embodiments, the user segment may be defined by the type or number of transactions the user makes, such as frequent withdrawals, deposits, or the like, the location at which the transactions occur, the type of payment, or the like.

In some embodiments, the user or an agent associated with the entity may manually input or select the criteria by which the user segment is defined. For example, if the agent wishes to advertise an offer to a specific group, the agent may a select specific criterion to target, such as demographic, interest, transaction amount, or purchasing habit. In other embodiments, a combination of criteria may define the user segment. Using more specific criteria in defining the user segment may result in more precision when the apparatus targets the user segment. The user segment may be named by the agent, the entity, the user, or the like in accordance with the existing nomenclature protocols of the entity. The entity may reserve the right to determine the name for the user segment.

Geo-location information may also be used in identifying the user segment. Geo-location information may comprise GPS coordinates, latitude and longitude coordinates, timestamp data (the time at which a transaction occurs), data associated with a geographic landmark or area, or the like. Using geo-location information, the apparatus may be able to identify patterns of business names or merchants that are patronized by the user base. Examples of merchants may be associated with travel and thus may include rental car companies, airlines, hotels, airports, restaurants, gas stations, travel pillow companies, or the like. Based on the determined patterns, the apparatus may be able to identify these merchants as “travel hubs,” or merchants commonly associated with travel. Furthermore, if through an analysis of user activity the apparatus determines that the user frequents travel hubs in a predetermined amount of time, then the apparatus may define the user to a “frequent traveler” user segment.

Additionally, analysis of geo-location information may enable the apparatus to differentiate between frequent travelers and employees of the travel hubs. For example, based on a combination of at least one of a timestamp, a frequency of transactions with the travel hub, location information associated with each transaction, or the like, the apparatus may be able to understand and assign the frequent traveler user and the employee of the travel hub user to two different user segments. Moreover, a thorough collection of data may enable the apparatus to project with some degree of certainty the future destination of a frequent traveler. In some embodiments, destination data (a gate, a date, a departure time, a destination city, or the like) may be presented to the user based on an analysis of user activity. In other embodiments, geo-location information may be used to exclude the user from the user segment. For example, if the user is deemed (based on geo-location information) to not be a “frequent traveler,” then the user may not be placed in the frequent traveler user segment.

In some embodiments, the apparatus may be further configured to divide the user segment into smaller user segments called micro segments. Micro segments enable the apparatus to be more precise in targeting a more specific group of users in the user base. As used herein, micro segment may refer to user segment, and vice versa.

After the user segment has been defined, the present invention may enable the apparatus to assign the users in the user base to the optimal user segments. As used herein, the “optimal” user segment may refer to the user segment of “best fit” or “most applicable” based on an analysis of the user's profile. The apparatus may assign probabilities of relevance of each user segment in order to determine which user segment is optimal for the user. In some embodiments, an automated process executable by the apparatus may determine which user segment is optimal for the user.

The apparatus may receive transaction data from the user's recent transactions. In some embodiments, the transaction data may be proprietary to the entity. In other embodiments, the transaction data may be public information. In some embodiments, the transaction data may be stored by the apparatus into a database of transaction data upon receipt. In some embodiments, the transaction data may be processed by the apparatus.

In processing the transaction data, the apparatus may analyze the transaction data. An analysis of the transaction data may include cross-referencing the received transaction data with an existing database of transaction data in order to identify the type of transaction, the type of businesses involved in the transaction, or the like. Furthermore, the user's information (contact information, information related to the user's account, purchasing habits, or the like) may be analyzed in order to identify the user's habits. In some embodiments, location information (global positioning system (GPS) coordinates, an entity's facility location, an address, or the like) may be analyzed by the apparatus. In some embodiments, a combination of transaction data, data crumbs, user information, and location information may be analyzed for precision of results. Based on the analysis of the transaction data, the apparatus may develop a logic map to determine which user segments are applicable to the user.

Using the logic map, the apparatus may project with some degree of certainty which applicable user segment is optimal for the user. The logic map may direct the apparatus in assigning a probability of relevance to each applicable user segment. This probability of relevance may be associated with a level of priority of the user segment in regards to the user.

For example, if the user resides in Florida, then a low priority (and therefore a low probability of relevance) may be assigned to the user segments associated with North Dakota. Conversely, if the user resides in Florida, then a high priority (and therefore a high probability of relevance) may be assigned to the user segments associated with Florida, Floridian cities, counties, or the southeast region. In some embodiments, the apparatus may rank or sort the list of applicable user segments based on the probability of relevance of the user segments. In other embodiments, the apparatus may rank or sort the list of applicable user segments based on other criteria, including but not limited to user segment name, data crumb categories, or the like. The apparatus may assign the user to the user segment based on the rankings of the applicable user segments. In analyzing the transaction data, the apparatus may also create a record of the user's transaction data and account information for later recall.

In some embodiments, only one user segment may apply to the user. In other embodiments, multiple user segments may apply to the user. When multiple user segments apply to the user, a probability of relevance may determine which user segment is optimal for the user. In some embodiments, the user may be associated with the user segment with the highest probability of relevance. The apparatus may automatically assign the user to the user segment whose probability of relevance is greater than a predetermined threshold of certainty. The threshold of certainty may define the critical point at which the apparatus determines the optimal user segment for the user. In other embodiments, the user may be associated with the user segment based on other factors, such as geographic location or transaction history.

Upon determining the optimal user segment for the user, the apparatus may assign the user to said optimal user segment. So, when the user's user segment is requested to be targeted in an advertising campaign, the user may be included in the target audience. The apparatus may request information related to the user, the user's account, the user's transaction data, the user's contact information, or the like. Additional security measures may be required to enable access to the user's information. For example, the user may grant the apparatus access to the user's information by entering a personal identification number (PIN), a passcode, a password, a biometric response (voice, fingerprint, retina or scan), an answer to a security question, or the like when prompted by the apparatus. In some embodiments, the apparatus may search the database for users with similar user profiles to further populate the user segment.

A category may be assigned to the user segment. Typically, once the optimal user segment has been determined for the user, the user and the user's account or account information is associated with the user segment. In some embodiments, the category may be created based on the user segment. This may occur if the user or the agent wishes to define a new user segment or rename an existing user segment. The category may include a title or a name used for identifying the user segment, wherein the category comprises text, an image, or the like. Once the user is assigned to the user segment, the apparatus may store the information, the association, the account information, or the like in a datastore or a database for later recall.

All in all, the apparatus may enable use of the user segment in targeting a specific demographic of the user base. For example, if the agent wishes to reach only female users who are over the age of 55 and live in Florida, then the agent may choose only the user segments which include this demographic. In some embodiments, the apparatus may direct the user to further execute an action associated with the user segments. In some embodiments, the user or the agent may be presented with a user interface with which the user is to select an executable action. In some embodiments, the user or the agent may be prompted to contact the entity or the agent associated with the entity, including a service center employee or an employee associated with a facility associated with the entity.

As used herein, an “offer” may refer to a discount, an advertisement, a message, or the like and may be used interchangeably. In some embodiments, the apparatus may generate the offer based on the user segment. For example, if the entity wishes to send a “One-Month Free!” advertisement to all women over the age of 55, the apparatus may be configured to do so. Clearly user segments are an efficient and effective method of organizing and managing a large user base. In alternate embodiments, the apparatus or the agent may determine which segment receives the offer based on the probability of relevance associated with the user segment. Typically, the apparatus will assign the offer to the user segment with the highest ranking probability of relevance, meaning that said user segment is the most applicable user segment to the user.

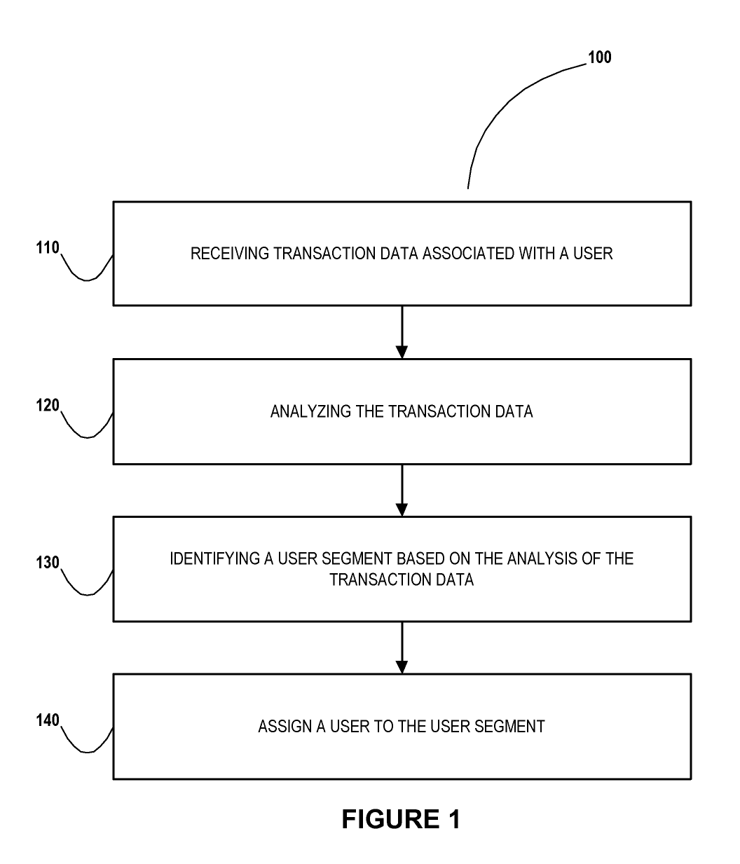

FIG. 1 illustrates a process flow 100 that explains the method of defining a user segment and assigning a user to said user segment. At block 110, the method comprises receiving transaction data associated with a user. At block 120, the method comprises analyzing the transaction data. At block 130, the method comprises identifying a user segment based on the analysis of the transaction data. At block 140, the method comprises assigning a user to the user segment.

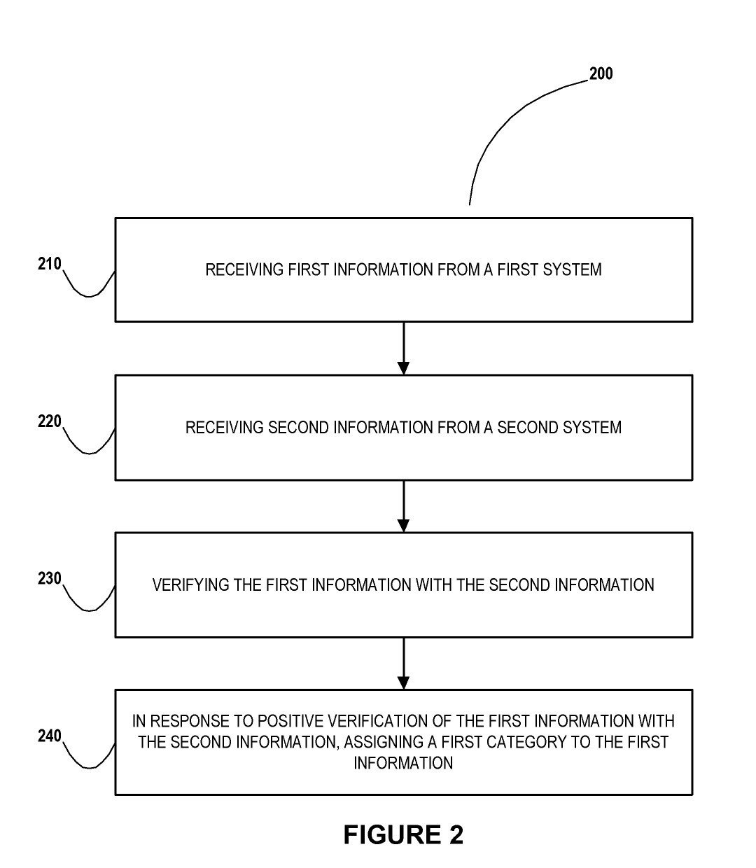

FIG. 2 illustrates a process flow 200 that explains the method of assigning a category to a user segment. At block 210, the method comprises receiving first information from a first system. At block 220, the method comprises receiving second information from a second system. At block 230, the method comprises verifying the first information with the second information. At block 240, the method comprises in response to positive verification of the first information with the second information, assigning a first category to the first information.

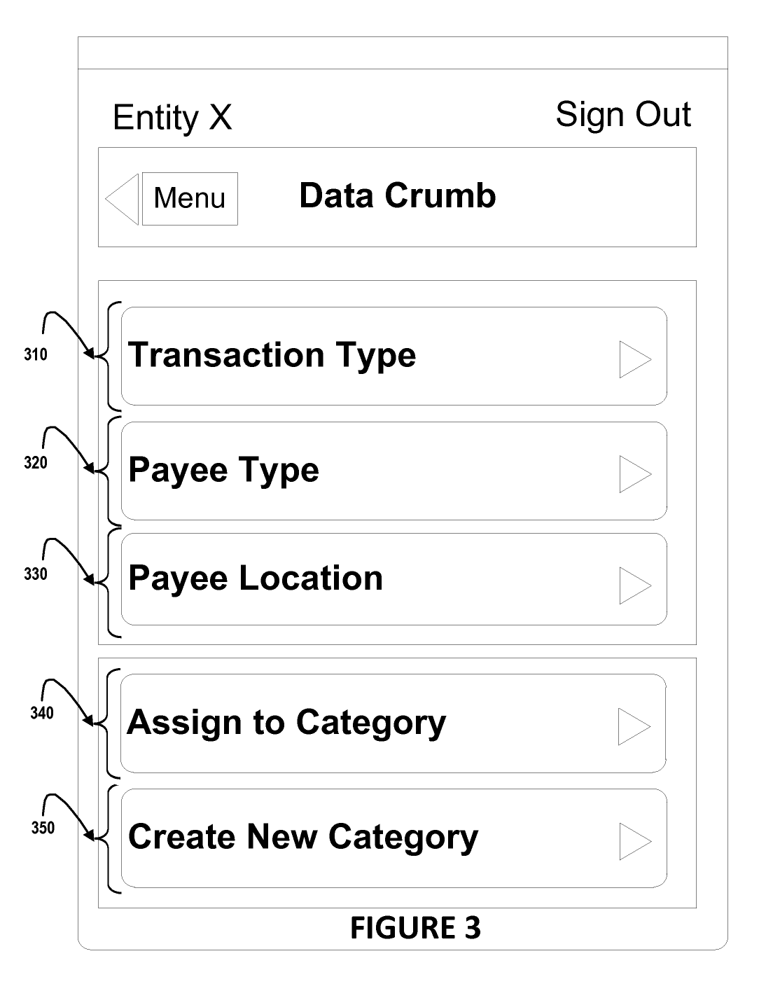

FIG. 3 illustrates an exemplary user interface for viewing information associated with a data crumb and creating a user segment. When the user selects the “Transaction Type” 310 tab, the user may be presented with the transaction type that is associated with the transaction. For example, the user may be presented with “withdrawal,” “deposit,” “credit card payment,” or the like. When the user selects the “Payee Type” 320 tab, the user may be presented with the category or type of business associated with the merchant. For example, if the data crumb is associated with a recent transaction at a fast food restaurant, the user may be presented with “restaurant.” The score associated with the relevance of the data crumb to the user segment may also be included in the “Payee Type” 320 tab. This score may aid the user in determining whether the data crumb may be assigned to an existing category or if the data crumb should be used to create a new category. When the user selects the “Payee Location” 330 tab, the user may be presented with information related to the payee's location. For example, if the user recently completed a transaction at a restaurant in Minnesota, the user may be presented with “Minneapolis.” Alternatively, the user may be presented with an address, GPS coordinates, a longitude or latitude, a network address or the like. When the user selects the “Assign to Category” 340 tab, the user may be presented with the option to assign the data crumb, a user associated with the data crumb, or information associated with the data crumb to a user segment. The user may be enabled to choose which user segment the data crumb is to be assigned. When the user selects the “Create New Category” 350 tab, the use may be presented with the option to create a new user segment. The user may be enabled to name the user segment or category.

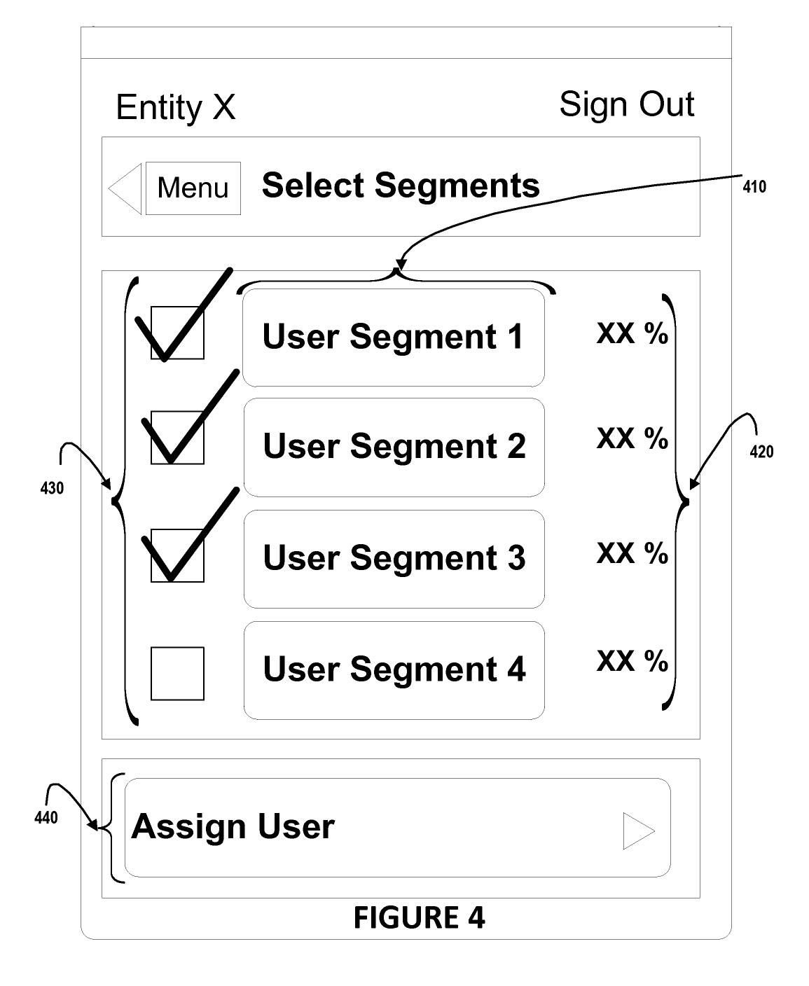

FIG. 4 illustrates an exemplary user interface for assigning the user to the user segment. A list of applicable user segments 410 is presented to the user. Each of the applicable user segments 410 have a probability of relevance 420 associated with the user segment's applicability. Based on these probabilities of relevance 420 the apparatus may rank or sort the applicable user segments 410. The user may select which user segments to assign the user by selecting the check box 430 next to each of the applicable user segments 410. The user may be assigned to one or multiple applicable user segments 410. When the user selects the “Assign User” 440 tab, the user is assigned to the selected applicable user segments 410.

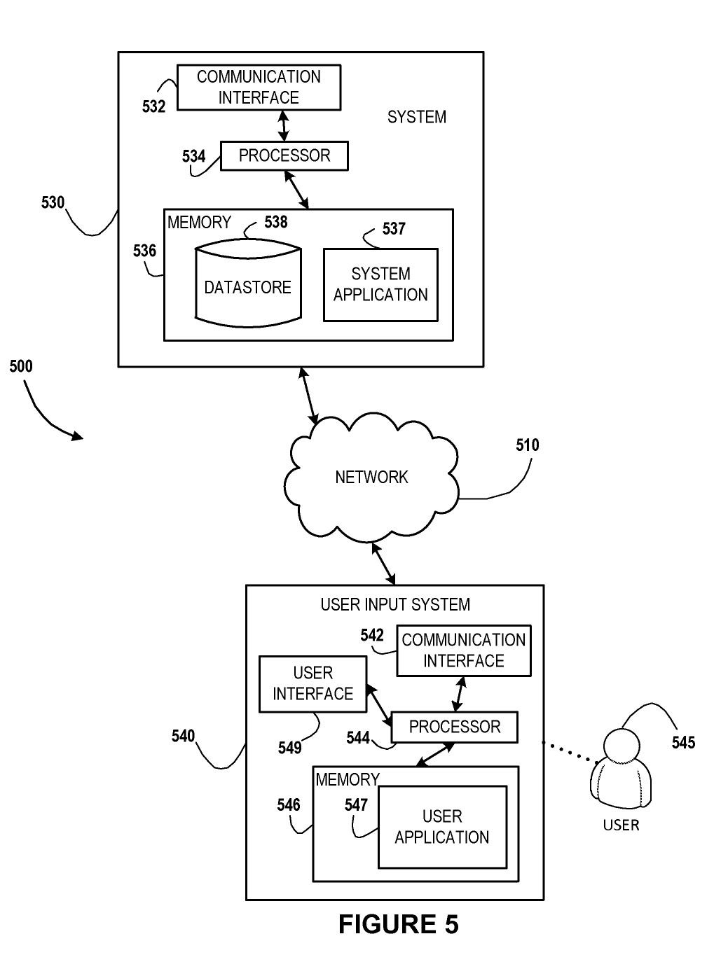

FIG. 5 presents an exemplary block diagram of the system environment 500 for implementing the process flows described in FIGS. 1 and 2 in accordance with embodiments of the present invention. As illustrated, the system environment 500 includes a network 510, a system 530, and a user input system 540. Also shown in FIG. 5 is a user 545 of the user input system 540. The user input system 540 may be a mobile device described herein. The user 545 may be a person who uses the user input system 540 to execute a user application 547. The user application 547 may be an application to communicate with the system 530, perform a transaction, input information onto a user interface presented on the user input system 540, or the like. The user application 547 and/or the system application 537 may incorporate one or more parts of any process flow described herein.

As shown in FIG. 5, the system 530 and the user input system 540 are each operatively and selectively connected to the network 510, which may include one or more separate networks. In addition, the network 510 may include a telecommunication network, local area network (LAN), a wide area network (WAN), and/or a global area network (GAN), such as the Internet. It will also be understood that the network 510 may be secure and/or unsecure and may also include wireless and/or wireline and/or optical interconnection technology.

The user input system 540 may include any computerized apparatus that can be configured to perform any one or more of the functions of the user input system 540 described and/or contemplated herein. For example, the user 545 may use the user input system 540 to transmit and/or receive information or commands to and from the system 530. In some embodiments, for example, the user input system 540 may include a personal computer system (e.g. a non-mobile or non-portable computing system, a motor vehicle, or the like), a mobile computing device, a personal digital assistant, a mobile phone, a tablet computing device, a network device, and/or the like. As illustrated in FIG. 5, in accordance with some embodiments of the present invention, the user input system 540 includes a communication interface 542, a processor 544, a memory 546 having an user application 547 stored therein, and a user interface 549. In such embodiments, the communication interface 542 is operatively and selectively connected to the processor 544, which is operatively and selectively connected to the user interface 549 and the memory 546. In some embodiments, the user 545 may use the user application 547 to execute processes described with respect to the process flows described herein. Specifically, the user application 547 executes the process flows described in FIGS. 1 and 2.

Each communication interface described herein, including the communication interface 542, generally includes hardware, and, in some instances, software, that enables the user input system 540, to transport, send, receive, and/or otherwise communicate information to and/or from the communication interface of one or more other systems on the network 510. For example, the communication interface 542 of the user input system 540 may include a wireless transceiver, modem, server, electrical connection, and/or other electronic device that operatively connects the user input system 540 to another system such as the system 530. The wireless transceiver may include a radio circuit to enable wireless transmission and reception of information. Additionally, the user input system 540 may include a positioning system. The positioning system (e.g. a global positioning system (GPS), a network address (IP address) positioning system, a positioning system based on the nearest cell tower location, or the like) may enable at least one of the user input system 540 or an external server or computing device in communication with the user input system 540 to determine the location (e.g. location coordinates) of the user input system 540.

Each processor described herein, including the processor 544, generally includes circuitry for implementing the audio, visual, and/or logic functions of the user input system 540. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 547 of the memory 546 of the user input system 540.

Each memory device described herein, including the memory 546 for storing the user application 547 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 5, the memory 546 includes the user application 547. The user application 547 may be associated with various features described herein. In some embodiments, the user application 547 includes an interface for communicating with, navigating, controlling, configuring, and/or using the user input system 540. In some embodiments, the user application 547 includes computer-executable program code portions for instructing the processor 544 to perform one or more of the functions of the user application 547 described and/or contemplated herein. In some embodiments, the user application 547 may include and/or use one or more network and/or system communication protocols.

Also shown in FIG. 5 is the user interface 549. In some embodiments, the user interface 549 includes one or more output devices, such as a display and/or speaker, for presenting information to the user 545. In some embodiments, the user interface 549 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 545. In some embodiments, the user interface 549 includes the input and display devices of a mobile device, which are operable to receive and display information.

FIG. 5 also illustrates a system 530, in accordance with an embodiment of the present invention. The system 530 may refer to the “apparatus” described herein. The system 530 may include any computerized apparatus that can be configured to perform any one or more of the functions of the system 530 described and/or contemplated herein. In accordance with some embodiments, for example, the system 530 may include a computer network, an engine, a platform, a server, a database system, a front end system, a back end system, a personal computer system, and/or the like. Therefore, the system 530 may be a server managed by the entity. The system 530 may be located at the facility associated with the entity or remotely from the facility associated with the entity. In some embodiments, such as the one illustrated in FIG. 5, the system 530 includes a communication interface 532, a processor 534, and a memory 536, which includes a system application 537 and a datastore 538 stored therein. As shown, the communication interface 532 is operatively and selectively connected to the processor 534, which is operatively and selectively connected to the memory 536.

It will be understood that the system application 537 may be configured to implement any one or more portions of the various user interfaces and/or process flow described herein. The system application 537 may interact with the user application 547. It will also be understood that, in some embodiments, the memory includes other applications. It will also be understood that, in some embodiments, the system application 537 is configured to communicate with the datastore 538, the user input system 540, or the like.

It will be further understood that, in some embodiments, the system application 537 includes computer-executable program code portions for instructing the processor 534 to perform any one or more of the functions of the system application 537 described and/or contemplated herein. In some embodiments, the system application 537 may include and/or use one or more network and/or system communication protocols.

In addition to the system application 537, the memory 536 also includes the datastore 538. As used herein, the datastore 538 may be one or more distinct and/or remote datastores. In some embodiments, the datastore 538 is not located within the system and is instead located remotely from the system. In some embodiments, the datastore 538 stores information or data described herein. For example, the datastore 538 may store information associated with the user's account.

It will be understood that the datastore 538 may include any one or more storage devices, including, but not limited to, datastores, databases, and/or any of the other storage devices typically associated with a computer system. It will also be understood that the datastore 538 may store information in any known way, such as, for example, by using one or more computer codes and/or languages, alphanumeric character strings, data sets, figures, tables, charts, links, documents, and/or the like. Further, in some embodiments, the datastore 538 may include information associated with one or more applications, such as, for example, the system application 537. It will also be understood that, in some embodiments, the datastore 538 provides a substantially real-time representation of the information stored therein, so that, for example, when the processor 534 accesses the datastore 538, the information stored therein is current or substantially current.

It will be understood that the embodiment of the system environment illustrated in FIG. 5 is exemplary and that other embodiments may vary. As another example, in some embodiments, the system 530 includes more, less, or different components. As another example, in some embodiments, some or all of the portions of the system environment 500 may be combined into a single portion. Likewise, in some embodiments, some or all of the portions of the system 530 may be separated into two or more distinct portions.

In addition, the various portions of the system environment 500 may be maintained for and/or by the same or separate parties. It will also be understood that the system 530 may include and/or implement any embodiment of the present invention described and/or contemplated herein. For example, in some embodiments, the system 530 is configured to implement any one or more of the embodiments of the process flows described and/or contemplated herein in connection any process flow described herein. Additionally, the system 530 or the user input system 540 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for assigning a user to a user segment, the apparatus comprising:
a memory;
a processor and
a module stored in the memory, executable by the processor, and configured to:
receive transaction data associated with a user;
analyze the transaction data;
identify a user segment based on the analysis of the transaction data;
assign a user to the user segment.

2. The apparatus of claim 1, wherein receiving transaction data further comprises searching a datastore of stored transaction data.

3. The apparatus of claim 2, wherein the transaction data comprises an image, text, data, or metadata.

4. The apparatus of claim 3, wherein the transaction data comprises information from a deposit, a check, a receipt, a withdrawal, a funds transfer, or a bill pay.

5. The apparatus of claim 1, wherein at least one of the first information or the second information comprises information associated with a purchase transaction, wherein the information comprises at least one of location information, a transaction type, a transaction date, a type of payment, a payment amount, a tip, a tax, or a discount associated with the transaction.

6. The apparatus of claim 5, wherein location information comprises geo-location information, a longitude and latitude, global positioning system (GPS) coordinates, a physical address, or a network address.

7. The apparatus of claim 1, wherein analyzing the transaction data further comprises developing a map of logic statements.

8. The apparatus of claim 7, wherein the map of logic statements determines the user segment for the user.

9. The apparatus of claim 1, wherein analyzing the transaction data further comprises associating a probability of relevance to at least one user segment applicable to the user.

10. The apparatus of claim 9, wherein analyzing the transaction data further comprises ranking the at least one user segment based on the probability of relevance of each user segment in order to determine the user segment for the user.

11. The apparatus of claim 1, wherein analyzing the transaction data further comprises creating a record of the user's transaction data.

12. The apparatus of claim 1, wherein identifying the user segment further comprises matching the user with the user segment based on a probability of relevance of the user segment.

13. The apparatus of claim 1, wherein assigning the user to the user segment further comprises associating the user and the transaction data with the user segment.

14. The apparatus of claim 1, wherein the user is assigned to at least one user segment.

15. The apparatus of claim 1, wherein the user segment is divided into at least one micro segment.

16. The apparatus of claim 1, wherein an agent associated with the apparatus targets and transmits to the user segment offers, products, services, marketing materials, or information.

17. The apparatus of claim 1, wherein the apparatus automatically transmits offers, marketing materials, products, services, or information to the user segment based on a probability of relevance associated with the user segment.

18. The apparatus of claim 1, wherein an agent associated with the apparatus determines a criterion and a name for the user segment.

19. A method for assigning a user to a user segment, the method comprising:
receiving transaction data associated with a user;
analyzing the transaction data;
identifying a user segment based on the analysis of the transaction data;
assigning a user to the user segment.

20. A computer program product for assigning a user to a user segment, the computer program comprising a non-transitory computer-readable medium comprising a set of codes for causing a computer to:
receive transaction data associated with a user;
analyze the transaction data;
identify a user segment based on the analysis of the transaction data;
assign a user to the user segment.
